(19) United States
(12) Patent Application Publication
(10) Pub. No.: US 2026/0142879 A1
(43) Pub. Date: May 21, 2026

(54) INTENT CENTRIC, POLICY ENFORCED OUT-OF-BAND DATA HANDLING INCREMENTAL NETWORK INTENT PROVISIONING

(71) Applicant: Cisco Technology, Inc., San Jose, CA (US)

(72) Inventors: Viktoria Fordos, Varmdo (SE); Erik Torbjorn Ryeng, Stockholm (SE)

(21) Appl. No.: 18/955,728

(22) Filed: Nov. 21, 2024

(51) Int. Cl. H04L 41/0894

(52) U.S. Cl. CPC H04L 41/0894

(57) ABSTRACT

A method for resolving an out-of-sync state occurring in a network. The method includes receiving, by a controller, a Minimal Configuration Change Diff (MCCD) associated with the out-of-sync state occurring in the network and determining, by the controller, by traversing the MCCD and at least one configuration node of the MCCD, the closest service instance associated with service meta-data received by the controller, and executing, by the controller, an Out-Of-Bound (OOB) policy associated with a determined closest service instance. Then, redeploying, by the controller, at least one service instance comprising an OOB configuration change based on an executed OOB policy that is associated with the determined closest service instance.

### TECHNICAL FIELD

The present disclosure relates generally to computer networking. More particularly, the present disclosure relates to systems and methods for efficient intent-centric and Out-Of-Band (OOB) data handling with policy enforcement for network orchestration.

### BACKGROUND

Network management systems are becoming more pervasive, causing previous assumptions of a sole owner or limited set of owners having access to data or devices within a network may no longer be deemed to be valid because of different entryways to the network (i.e., any previous conjectures on sole data ownership in a disparate or pervasive network would likely be incorrect as entries to the network become more readily accessible). Multiple systems may coexist in a network, and their effects or operations may overlap, causing inconsistencies in the dynamic operations of other systems. Network services orchestrators (e.g., CISCO® Crosswork NSO) are no different, and inconsistencies can affect service deployment, such as the intent to device configuration mappings.

Computer networks, as indicated, are ubiquitous and configured for accessibility and to allow for data transfer between multiple or various computing devices that are communicatively coupled. These computer networks may include connections between a few computing devices or potentially hundreds of thousands of disparate computing devices. Networks may be set up or managed with multiple levels of priorities and restrictions in the network so that authorized users, host computing devices, switches, routers, servers, and other network computing devices may gain access to applications on the network and communicate with one another. Network management may include creating connectivity between the computing devices within the network and configuring services such as security, monitoring, traffic copy, and QoS among those devices.

A network intent may be described as a computer network model, encompassing the definition of the network and how it is interconnected to provide connectivity and services. An intent-based network controller, for example, may take the network intent as input and, through network configurations, realize this intent on the network. Therefore, a description of network intent may be altered to correspond with changes in the network. In many management operations, a part of the network intent may require modification, wherein minimal changes are made to several computing devices within the network. Some network intent models used to configure changes in a network alternately may be very large, resulting in larger configurations and other management times. Indeed, as the size of the network grows, the size of the associated configuration change intent also grows, increasing the deployment time. Thus, for extensive networks including tens of thousands of computing devices, configuration device changes, even minimal changes in a relatively small number of computing devices within the computing network, may take considerable time and computing resources to accomplish since a comparison between all the attributes and associations of the nodes or computing devices within the existing network and the user's or administrator's intended configuration device changes (e.g., network intent) of the network must be performed.

### BRIEF DESCRIPTION OF THE DRAWINGS

The detailed description is set forth below with reference to the accompanying figures. In the figures, the left-most digit(s) of a reference number identifies the figure in which the reference number first appears. The use of the same reference numbers in different figures indicates similar or identical items. The systems depicted in the accompanying figures are not to scale and components within the figures may be depicted not to scale with each other.

FIG. 1 illustrates a system architecture diagram of an intent-based network of a Network Services Orchestrator (NSO) system, including a network controller for enabling higher-order functions that transform intent into at least Out-Of-Bound (OOB) device configuration changes of a network, according to an example of the principles described herein.

FIG. 2 illustrates a component diagram of example components of a Network Service Orchestrator within the Network Service Orchestrator system of FIG. 1, according to an example of the principles described herein.

FIG. 3 illustrates a module of code that calls an exemplary service A, which may be deployed for device configuration of a Network Service Orchestrator within the Network Service Orchestrator system of FIG. 1, according to an example of the principles described herein.

FIG. 4 illustrates a module of code that calls multiple services (e.g., Services A and B) that may be deployed for device configuration of a Network Service Orchestrator within the Network Service Orchestrator system of FIG. 1, according to an example of the principles described herein.

FIG. 5 illustrates a module of code of a shared device configuration of multiple services (e.g., Services A and B) that may be deployed for device configuration of a Network Service Orchestrator within the Network Service Orchestrator system of FIG. 1, according to an example of the principles described herein.

FIG. 6 illustrates a module of code with references to back pointers and counters for a shared device configuration of multiple services (e.g., Services A and B) that may be deployed for device configuration of a Network Service Orchestrator within the Network Service Orchestrator system of FIG. 1, according to an example of the principles described herein.

FIG. 7 illustrates a module of code of intent that may be deployed for device configuration with the service meta-data of a Network Service Orchestrator within the Network Service Orchestrator system of FIG. 1, according to an example of the principles described herein.

FIG. 8 illustrates a module of code that may be deployed for device configuration in which modifications have been performed by a service instance for use by a Network Service Orchestrator within the Network Service Orchestrator system of FIG. 1, according to an example of the principles described herein.

FIG. 9 illustrates a module of code of intent that may be deployed for device configuration with Out-Of-Bound policies used with a Network Service Orchestrator within the Network Service Orchestrator system of FIG. 1, according to an example of the principles described herein.

FIG. 10 illustrates a module of code of intent that may be deployed for device configuration, which allows modification on device mapping, allows modification below a device mapping, and disallows modification below the device mapping for use with a Network Service Orchestrator within the Network Service Orchestrator system of FIG. 1, according to an example of the principles described herein.

FIG. 11 illustrates a module of code that triggers a sync operation to the Network Service Orchestrator to recognize OOB configuration changes performed in FIG. 10 within the Network Service Orchestrator system of FIG. 1, according to an example of the principles described herein.

FIG. 12 illustrates a module of code that may be deployed for device configuration in which modifications have been performed by a service instance with an attached Out-Of-Bound (OOB) configuration change for use by a Network Service Orchestrator within the Network Service Orchestrator system of FIG. 1, according to an example of the principles described herein.

FIGS. 13A, 13B, and 13C illustrate flow diagrams of an Out-Of-Bound (OOB) configuration change method according to the principles described herein.

FIG. 14 illustrates a computing system diagram illustrating a configuration for a data center that may be utilized to implement aspects of the technologies disclosed herein.

FIG. 15 illustrates a computer architecture diagram showing an example of computer hardware architecture for implementing a computing device that may be utilized to implement aspects of the various technologies presented herein.

### DESCRIPTION OF EXAMPLE EMBODIMENTS

For intent-centric, policy-enforced Out-Of-Band (OOB) data handling, various methodology is introduced that enables OOB configuration changes, connect OOB configuration changes with intent, allow an approved OOB configuration change to have the same or similar lifecycle as the intent, and allow fine-grained policy enforcement on OOB configuration changes in a fully automated fashion.

Various examples are provided with systems and methods for intent-centric, policy-enforced OOB data handling, including enabling a fully automated framework that uses a network services orchestrator to attach approved OOB configuration changes to intents and removes rejected OOB configuration changes from the network via user-defined policies; approving OOB configuration changes that have the same lifecycle as the intent, reducing operational complexity; making intent-based configuration changes are guaranteed to work with up-to-date device configuration data, ensure safe and correct configuration change execution, and determining whether an intent-centric policy is compatible with the OOB configuration changes.

Various examples are provided with systems and methods for supporting intent-based automation of the network services orchestrator and use, along with stateful storage of device data that is modeled in a tree format (e.g., YANG) and changing a request when an intent-based configuration arrives at the network services orchestrator via its northbound Application Programming Interface (API), the transactional manager initiates a new transaction object to handle the request.

Various examples are provided with systems and methods for deploying a service that includes at least a Virtual Private Network (VPN) service or other services that describe or may describe the intent and can map it to device configurations. The mapping can enable fulfilling the intent for every service; OOB configuration mappings are allowed (i.e., OOB configuration changes be attached to the intent), ignored (i.e., OOB configuration changes are not attached to the intent), or rejected (i.e., revert the OOB configuration changes based on the network services orchestrator's datastore), the deviations expressed by the OOB policies, which are a list of rules.

Various examples are provided with systems and methods that enable, upon receiving a configuration change from the network device, the network services orchestrator to use a method comprising at least the YANG-Push method to update its datastore and ensure synchronization between the two systems;

Various examples are provided with systems and methods for processing a Minimal Configuration Change Difference (MCCD) arriving at the network services orchestrator. In some instances, an MCCD is configured to be executed by the NSO upon a first case, a second case, or a third case comprising the first case of a configuration change being delivered to at least one network device, the second case being a configuration change caused by an on-change subscription process such as a YANG-push or other device event, and the third case being upon copying over of a partial or complete (i.e., full) running configuration of a device to the NSO. In some instances, the MCCD is calculated by the NSO in accordance with at least one of the first, second, or third cases for forwarding toward a communicatively connected datastore for enabling the datastore to be synced with one or more configured network devices.

In some instances, the MCCD is traversed, and for each configuration node, using service meta-data, find the closest service instance(s) and run OOB policies defined by the identified service instance. In some instances, the OOB policies of each service are evaluated in the order, and the evaluation stops at the first match.

In some instances, if the OOB configuration changes are accepted, attach the OOB configuration to service instance(s); if the OOB configuration changes are ignored, add the OOB configuration to the network services orchestrator datastore; if OOB configuration changes are rejected, using the datastore of the network services orchestrator, send the compensating transaction to the device to restore the configuration subtree rooted at the rejected OOB configuration change; redeploy all affected service instances (service instances that have got OOB configuration attached to them);

Various examples are provided with systems and methods for discovering the closest service instance(s) by using the network services orchestrator's datastore and then discovering the closest parent node to the configuration node in question that has service meta-data on it where the parent's node back pointers define which service instances own the OOB configuration.

Various examples are provided for attaching OOB configurations to one or more service instances and recording and storing operations required to create an OOB configuration on a device, at least one of under the service instance's private data or remote of the NSO.

Various examples are provided to redeploy all affected service instances (service instances that have got OOB configuration attached to them) to ensure that the device configuration mapping is deployed according to the current intent; to read and execute the OOB create operations stored under the private data of the service instance; and to enable all configuration nodes created in this step are tagged with service meta-data: reference counters and back pointers pointing to the service instances that own the OOB.

Various examples are provided for attaching the OOB configuration changes to the affected service instances and tagging them with service meta-data enables the OOB configuration changes to have the same lifecycle as the intent, wherein attaching the OOB configuration changes to the affected service instances enables the network services orchestrator to ensure that the OOB configuration changes are present on the device whenever the intent is deployed or modified; and for tagging the OOB configurations with service meta-data enables the network services orchestrator to remove OOB configuration changes from the devices when the intent is removed; and configuring the OOB configuration changes approved by user-defined policies will align with the same lifecycle as the intent deployment before us, ensuring consistent policy enforcement and streamlined operations.

The present disclosure provides enhanced means to propagate both efficiently and accurately changes (including Out of Band (OOB) Changes) in device configurations by creating network automation tools with an intent-centric view of OOB configuration changes and by providing a more flexible intent-to-device mapping to meet all or most customer requests.

### Overview

Examples described herein provide a method of configuring device changes in a network utilizing an intent-based network controller such as a network service orchestrator. When an intent-based configuration change request arrives at the network services orchestrator via its northbound API, the transactional manager initiates a new transaction object to handle the request. This enables the transactional manager to cause all or most of the read-and-write operations of the request to be performed through the transaction object. When the transaction is being executed or is executed, the transaction object invokes one or more services that can implement the transaction intent. In this instance, the various services are implemented with abstractions that map the intent to device configurations, thereby generating an intent-based configuration change for the network (e.g., deployment of VLAN).

In some examples, to avoid unexpected device configuration removals, the generated device configurations are tagged with service meta-data (e.g., back pointers to the service instance) that express service ownership information to distinguish upon an intent removal. The service invocation outcome, combined with service ownership information, becomes part of the transaction object. In some examples, when a transaction is executed, it is subject to various validations and consistency checks by the transactional manager, and if it is deemed to have passed certain validation and consistency checks, a data store that is configured to receive updates from one or more transactions is permitted or allowed (i.e., not restricted) to be updated with one or more changes recorded by the transaction object. Further, in instances dependent on the type of change or permitted for all changes, the change or changes can or are propagated to the connected or communicable network devices via a service manager or a higher-level component configured to send commands to lower-level network components (e.g., a southbound API of the network services orchestrator).

In some examples, incoming device events (e.g., YANG-Push, gnmi events) are handled by a notification API configured with the network services orchestrator. For instance, intent-centric OOB changes may be examples of incoming device events managed by the orchestrator's notification API.

In some examples, an intent (e.g., deploying a VPN service) can be fulfilled by executing the service that describes the intent and maps it to device configurations. The mapping may be well-defined and used as a necessary component to fulfill the intent. Hence, for every service, with this flexible mapping, it can be defined what deviations (OOB configuration changes) are to be made on and below device configuration mappings and which at least one of the configuration changes is to be allowed, ignored, rejected or as defined on the part of an OOB policy on a per device basis. In some examples, the deviations can be expressed by OOB policies and a list of rules.

In some examples, a rule may be configured as a two-tuple that is a match expression in any matching format (e.g., regex, Xpath) to match against the configuration node and an action (e.g., accept, ignore, and reject).

In some examples, an “accept” operation is defined when one or more OOB configuration changes should be or must be attached to the intent. The service will take ownership of the OOB configuration changes by tagging the configuration changes with service meta-data. The OOB configuration will have the same lifecycle as the intent: it is ensured to exist on the device while the intent is deployed. The OOB configuration and the device configuration mapping are removed upon intent removal.

In some examples, an “ignore” action is defined when the OOB configuration changes are allowed but not attached to the intent. The OOB configuration changes are stored in the network services orchestrator's datastore.

In some examples, a “reject” action is defined when the OOB configuration changes are not allowed. A compensating transaction is sent to the device, which in turn may cause the OOB configurations to revert to a previous state based on the network services orchestrator's datastore.

In some examples, the network service orchestrator is configured to automatically determine or detect one or more different out-of-sync types of cases.

In some examples, the following illustrate three different types of out-of-sync cases that the network services orchestrator may manage.

In the first case, as an example, a ubiquitous configuration change being delivered toward a network device may be detected by the network services orchestrator.

In a second case, for example, a configuration change may cause an on-change subscription process such as a YANG-Push, resulting in a configuration change delivery to be distributed to one or more of the network devices and recognized by the network services orchestrator.

In a third case, upon copying over the partial or complete running configuration of the device to the network services orchestrator, the network services orchestrator may be configured to calculate a minimal configuration change difference (referred to as “MCCD”) as an update towards an associated datastore to ensure that the related datastore is in configured to be sync with the one or more network devices.

In some examples, a Minimal Configuration Change Diff (MCCD) arrives at the network services orchestrator. In this instance, the MCCD is traversed. For each configuration node, using service meta-data; the network services orchestrator is configured to find the closest service instance(s) to run OOB policies defined by the identified service instances. The OOB policies of each service may be evaluated in order, and the evaluation may terminate (e.g., stops) when a first match of a service instance is discovered. Upon the match of the service instance, various actions may occur by the network services orchestrator, including the following: If the OOB configuration changes are accepted, attach the OOB configuration to service instance(s); if the OOB configuration changes are ignored, add the OOB configuration to the network services orchestrator datastore; if OOB configuration changes are rejected, using the datastore of the network services orchestrator, may send or distribute the compensating transaction to one or more devices to restore the configuration subtree rooted at the rejected OOB configuration change; redeploy all affected service instances (service instances that have received OOB configuration attached to them).

In some examples, the network services orchestrator may determine or find the closest service instance(s) rather than an exact or approximate match. In this instance, using the network services orchestrator's datastore, the network services orchestrator is configured to find the closest parent node to the configuration node in question that has service meta-data on it; the parent's back pointers define which service instances are associated with the OOB configuration.

In some examples, the network services orchestrator may attach an OOB configuration change to one or more service instance(s). In this instance, the network services orchestrator may be configured to record and store operations required or needed to create the OOB configuration on the device under the data or private data of the service instance.

In some examples, the network services orchestrator is configured to redeploy some or all affected service instances. For example, one or more service instances that have received OOB configuration are attached or associated with the particular service instance. This, in turn, may ensure that the device configuration mapping is deployed according to the current intent. In some examples, the network services orchestrator is configured to read and execute the OOB configuration change and create operations stored under the private data of the service instance. In some examples, several, nearly all, or all configuration nodes created during the attachment of the service instance or deployment of the device configuration mapping are tagged with service meta-data for identification. Also, reference counters and back pointers point to the service instances that possess or are with the OOB configuration change. In some examples, the network services orchestrator is configured to attach the OOB configuration change to the affected service instance and then tag the service instance with service meta-data that may enable the OOB configuration change to have a similar lifecycle or existent congruous to a lifecycle or existence of the intent (i.e., an intent centric policy being enforced).

In some examples, the network services orchestrator is configured to attach the OOB configuration changes to the affected service instances to enable the network services orchestrator to ensure that the OOB configuration changes occur on the device whenever the intent is deployed or when the intent is to be modified.

In some examples, the network services orchestrator is configured to tag the OOB configurations with service meta-data, which enables the network services orchestrator to selectively remove OOB configuration changes from the devices when the intent is removed.

In some examples, the network services orchestrator is configured to enable the configuring of one or more OOB configuration changes that have been approved by intent-centric policies or by user-defined policies and for aligning the OOB configuration changes with a similar or identical lifecycle as an intent-based deployment that is being performed. This ensures that consistent policy enforcement is applied and the policy enforcement is optimized for one or more client or network devices in operations (i.e., a streamlined enforcement of OOB configuration changes among devices).

In some examples, the techniques described herein relate to a method for resolving an out-of-sync state occurring in a network, including: with a controller: receiving, by the controller, a Minimal Configuration Change Diff (MCCD) associated with the out-of-sync state occurring in the network; determining, by the controller, by traversing the MCCD and at least one configuration node of the MCCD, a closest service instance associated with service meta-data received by the controller; executing, by the controller, an Out-Of-Bound (OOB) policy associated with a determined closest service instance; and redeploying, by the controller, at least one service instance including an OOB configuration change based on an executed OOB policy that is associated with the determined closest service instance.

In some examples, the techniques described herein relate to a non-transitory computer-readable medium storing instructions that, when executed, cause a processor to perform operations, including: receiving a Minimal Configuration Change Diff (MCCD) associated with an out-of-sync state occurring in a network; determining by traversing the MCCD and at least one configuration node of the MCCD, a closest service instance associated with service meta-data; executing an Out-Of-Bound (OOB) policy associated with a determined closest service instance; and redeploying at least one service instance including an OOB configuration change based on an executed OOB policy that is associated with the determined closest service instance.

In some examples, the techniques described herein relate to a network controller including: a processor; and a non-transitory computer-readable media storing instructions that, when executed by the processor, causes the processor to perform operations including: receiving a Minimal Configuration Change Diff (MCCD) associated with an out-of-sync state occurring in a network; determining by traversing the MCCD and at least one configuration node of the MCCD, a closest service instance associated with service meta-data received; executing an Out-Of-Bound (OOB) policy associated with a determined closest service instance; and redeploying at least one service instance including an OOB configuration change based on an executed OOB policy that is associated with the determined closest service instance.

Examples described herein also provide a non-transitory computer-readable medium storing instructions that, when executed, cause a processor to perform operations, including, with a network controller, for executing an intent-based change in a network comprising: receiving a request for a configuration change for distributing within a network wherein the configuration change comprises an intent-based configuration change for the network; generating a transaction object to handle the intent-based configuration change for the network; enabling at least one of a read operation or a write operation via the transaction object; processing the transaction object to cause at least the one of the read operation or the write operation to generate a service invocation that results in the intent-based configuration change; and mapping the intent-based configuration change for at least one service based on a service abstraction associated with the service invocation that results in a device configuration change.

Examples described herein also provide a network controller including a processor and a non-transitory computer-readable media storing instructions that, when executed by the processor, causes the processor to perform operations further, including tagging the device configuration change with service meta-data associated with service ownership that is associated with at least one of the device configuration change or with the intent-based configuration change for the network; executing a Minimal Configuration Change Diff (MCCD) initially, and in response to an OOB configuration change, traversing the MCCD and using service meta-data for discovering the closest service instance; and further executing at least one OOB policy defined by an identified service instance wherein the OOB policies are evaluated based on a priority of definitions, terminating upon an appropriate match.

Additionally, the techniques described in this disclosure may be performed as a method and/or by a system with non-transitory computer-readable media storing computer-executable instructions that perform the abovementioned techniques when executed by one or more processors.

### Example Embodiments

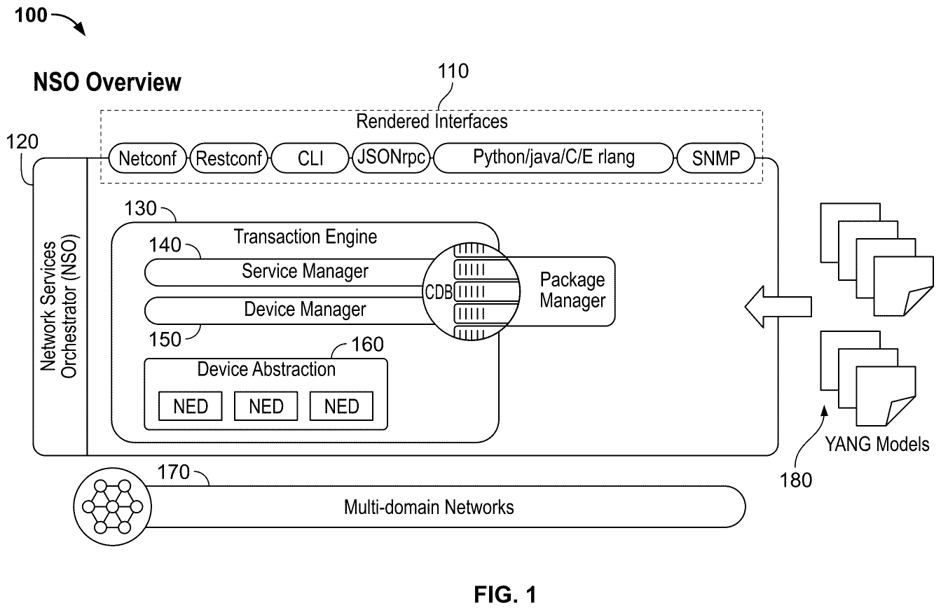

Turning now to the figures, FIG. 1, FIG. 1 illustrates a system architecture diagram of an intent-based networking system, including a Network Services Orchestrator (i.e., the network controller) for enabling higher-order functions that transform intent into device configurations such as Out-Of-Band Configuration changes of a network, according to an example of the principles described herein.

In FIG. 1, an intent-based networking system (IBN) is shown, which includes a Network Services Orchestrator (NSO) system 100. The NSO system 100 includes a number of different interfaces: 110, a network service orchestrator (NSO) 120, a transaction engine 130 that contains a service manager 140 and device manager 150, and a device abstraction 160.

In some examples, the NSO 120 is configured in a framework for receiving one or more MCCDs. In this instance, An MCCD arrives at the network services orchestrator.

The MCCD is traversed, and for each configuration node, Using service meta-data, find the closest service instance(s). In some examples, the NSO 120 executes one or more policies defined by the identified service instances. OOB policies of each service are evaluated in the order they are defined, and the evaluation stops at the first match.

In some examples, the NSO 120 is configured to perform the following steps: If OOB configuration changes are accepted, attach OOB configuration to service instance(s); If OOB configuration changes are ignored, add OOB configuration to the datastore of the network services orchestrator; If OOB configuration changes are rejected, using the datastore of the network services orchestrator, send compensating transaction to the device to restore the configuration subtree rooted at the rejected OOB configuration change. In this instance, the NSO 120 is configured to redeploy all affected service instances (with OOB configuration attached).

In some examples, the NSO 120 is configured to find the closest service instance(s). Using the network services orchestrator's datastore, find the nearest parent node to the configuration node with service meta-data. The parent's back pointers define which service instances own the OOB configuration.

In some examples, the NSO 120 is configured to attach OOB configuration to service instance(s), record and store operations required to create OOB configuration on the device under the private data of the service instance, and redeploy all affected service instances (service instances that have got OOB configuration attached to them). In some examples, the NSO 120 is configured to ensure that the device configuration mapping is deployed according to the current intent and reads and executes OOB create operations stored under the private data of the service instance. For example, all or nearly all configuration nodes created in this step are tagged with service meta-data: reference counters and back pointers that point to the service instances that own the OOB. In some examples, the NSO 120 is configured to attach OOB configuration changes to the affected service instances, and tagging them with service meta-data enables the OOB configuration changes to have the same lifecycle as the intent. (1) Attaching OOB configuration changes to the affected service instances enables the network services orchestrator to ensure that the OOB configuration changes are present on the device whenever the intent is deployed or modified. Also, the NSO 120 is configured to tag OOB configurations with service meta-data, enabling the network services orchestrator to remove OOB configuration changes from the devices when the intent is removed.

In some examples, the interfaces 110 may include rendered interfaces such as netconf (NETCONF (RFC 6241), an XML-based protocol that client applications use to request information from and make configuration changes to the device, Restconf (an HTTP-based protocol that provides a programmatic interface for accessing data defined in YANG, Also included is a command line interface (CLI) is a text-based interface where input commands interact with a processor-based operating system. Also, by using the datastore defined in the Network Configuration Protocol, a JSON-RPC (JavaScript Object Notation-Remote Procedure Call) may also be used, which is a remote procedure call (RPC) protocol encoded in JSON (protocol that defines only a few data types and commands). JSON-RPC allows for notifications (data sent to the server that does not require a response) and for multiple calls to be sent to the server, which may be answered asynchronously, programming languages (Python, Java, C, Eriang), and Simple Network Management Protocol (SNMP) are network protocols that may be used to enable users to monitor and manage devices connected to the network.

The device abstraction 160 may include a set of Network Device Extensions (NEDs) to acquire, process, store, and distribute data for multiple systems and applications. It can also manage Quality of Service (QoS), allowing operators to prioritize traffic for critical applications.

The multi-domain network 170 is a network architecture that connects multiple domains or networks and may include a master domain coupled to a series of tiered domains configured with protocols for enabling communications between each domain manager in respective domains in the network.

The YANG model 180 is implemented by the NSO 120. The NSO 120 uses YANG models 180 for service models and specifies device interfaces (device abstractions 160 and rendered interfaces 110). The YANG service model may be defined as part of the service design activity. The NSO 120 ships several examples of service models that can be used as a starting point. For devices, it depends on the underlying device interface (rendered interface 110) and how the YANG model is derived. For native NETCONF/YANG devices, the device gives the YANG model. For SNMP devices, the NSO 120 toolchain generates the corresponding YANG modules (SNMP NED). For CLI devices, the package may contain the YANG data model. This is shipped in text and can be modified for upgrades. Users can also write their YANG data models to render the CLI integration (CLI NED). The situation for other interfaces is similar to CLI; a YANG model corresponding to the device interface data model is written and bundled in the NED package.

In other examples, the NSO 120 may enable services within the network through a number of setup processes. For example, the NSO 120 may enable network settings where the NSO 120 when starting up network servers including, for example, authentication, authorization, and accounting (AAA) servers, dynamic host configuration protocol (DHCP) servers, domain name system (DNS) servers, Network Time Protocol (NTP) servers, NetFlow exporters, other servers, and combinations thereof. The NSO 120 may also have wireless settings such as service set identifiers (SSIDs) and wireless interfaces between the computing devices within the network.

In some examples, the network services orchestrator 120 may configure the computing devices within the network to enable the service functionalities described above. Thus, to achieve the intent state defined by the administrator, the computing devices within the network are configured; the network services orchestrator 120 may allow the administrator to define networking intents at a relatively higher level of abstraction that is user-friendly and intuitive. The Network Services Orchestrator 120 may include a number of applications and services to assist in receiving the network intent from the administrator at the client device or the Network Services Orchestrator 120 itself.

In some examples, the network services orchestrator (network controller) 120 may be implemented on any type of computing network, including, for example, a local area network (LAN), a home area network (HAN), a storage area network (SAN), a campus area network (CAN), a metropolitan area network (MAN), a wide area network (WAN), an enterprise private network, and virtual private network (VPN), an internet area network (IAN) (e.g., a cloud computing network), an internet (including the Internet), a service provider network, and a data center network, among a myriad of other types of computing networks, and combinations thereof. Further, the present systems and methods may be applied among various networks, including different types of networks. In one example, the network services orchestrator 120 may be integrated with or include or comprise a CISCO® DNA Center network controller and management dashboard developed and distributed by CISCO® Systems, Inc.

In some examples, the NSO system 100 may be included in any type of computing device, such as networking devices. The computing devices within the network may include, for example, servers, routers, switches, client computing devices, relays, repeaters, encoder/receiver/transmitters (ERTs), appliances, personal computers (e.g., desktop computers, laptop computers, etc.), mobile devices (e.g., smartphones, tablets, personal digital assistants (PDAs), electronic reader devices, etc.), wearable computers (e.g., smart watches, optical head-mounted displays (OHMDs), etc.), access points, and gateway computing devices, among a myriad of other network computing devices, and combinations thereof. An administrator may design the NSO system 100 to include a number of the computing devices and may define, identify, and store data about the computing devices of the NSO system 100 in a data storage device within the NSO system 100 or by a third-party device such as the network controller and/or a client device.

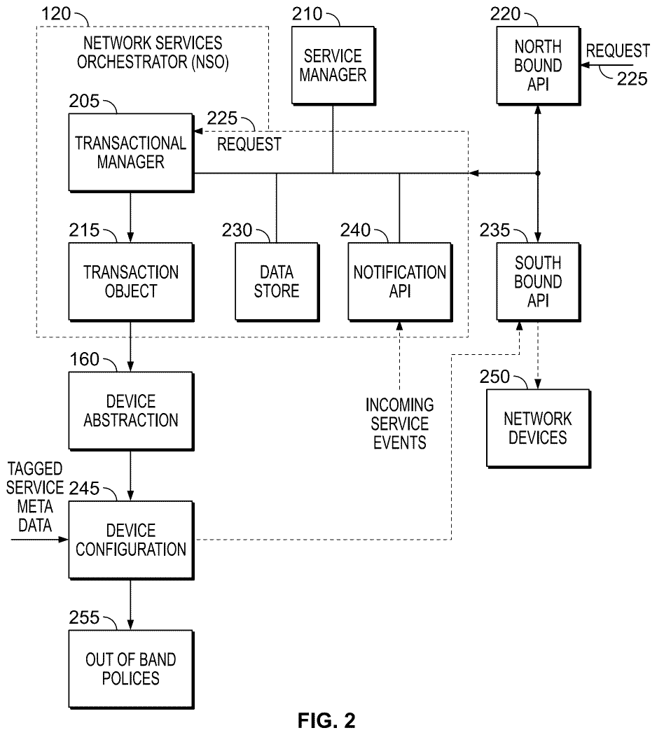

FIG. 2 illustrates a component diagram of example components of a Network Services Orchestrator 120 within the Network Service Orchestrator system 100 of FIG. 1, according to an example of the principles described herein.

In some examples, the network services orchestrator (NSO) 120 or network controller may include a transactional manager 205, a service manager 210, a set of interfaces or protocols that consist of APIs 220 such as a southbound API and a northbound (e.g., the northbound API allows a lower-level network component to communicate with a higher-level or more central component, while a southbound API allows a higher-level component to send commands to lower-level network components), a datastore 230, and a notification API 240.

When an intent-based configuration change request arrives at the network services orchestrator 120 via an interface such as the northbound API, the transactional manager 205 is configured to initiate a new transaction object 215 to handle the request 225. The read and write operations of the request 225 are passed through the transaction object 215. When the transaction is executed, transaction object 215 invokes services implementing the transaction intent. Services are abstractions 160 that map intent to device configurations 245 (e.g., deployment of VLAN). To avoid unexpected device configuration removal upon intent removal, the generated device configurations are tagged with service meta-data (e.g., back pointers to the service instance) that express service ownership information. The outcome of service invocation, together with service ownership information, becomes part of the transaction object. Suppose the transaction passes validation and consistency checks. In that case, the datastore 230 is updated with the changes recorded by the transaction object 215, and the changes are propagated to the network devices 250 via the southbound API 235 of the network services orchestrator 120. Incoming device events (e.g., YANG-Push, gami events) are handled by the notification API 240 of the network service orchestrator.

In some examples, An intent (e.g., deploy a VPN service) can be fulfilled by executing the service (via the device abstraction 160) that describes the intent and maps it to device configurations 245 to network devices 250. The mapping is well-defined and is considered necessary to complete the intent. Hence, for every service, one can define what deviations (OOB configuration changes) on and below the device configuration 245 mappings are allowed, ignored, or rejected. These deviations can be expressed by OOB policies 255, a list of rules.

The OOB policies may be expressed in rule configurations consisting of a two-tuple, a match expression in any matching format (e.g., regex, Xpath) to match against the configuration node, and an action (e.g., accept/ignore/reject). When an accept action occurs, the OOB configuration is attached to the intent, and the service will assume ownership of the OOB configuration by a tagging operation to tag meta-data associated with the service. The OOB configuration will have the same lifecycle as the intent: it is ensured to exist on the device while the intent is deployed. The OOB configuration is removed based on an intent removal action and the device configuration mapping. When an ignore action occurs, the OOB configuration changes are allowed, but the configuration changes are not attached to the intent.

In this case, the OOB configuration changes are stored in the datastore 230 of the network services orchestrator 120. Suppose the OOB configuration changes are rejected (e.g., not allowed). In that case, a revert action may cause the OOB configuration to revert to a previous state based on the network orchestrator's datastore.

In some examples, the network service orchestrator is configured to determine or detect one or more different out-of-sync cases automatically.

In some examples, the following illustrate three different types of out-of-sync cases that the network services orchestrator may manage.

In the first case, as an example, a ubiquitous configuration change being delivered toward a network device may be detected by the Network Services Orchestrator (NSO). In some examples, the ubiquitous configuration change is an intent-based configuration change arriving at the NSO where the NSO may process the change as part of a transaction object, and it may include a service invocation comprising a service output that is tagged with service meta-data becoming part of the transactional object, a transaction validity check, and a transaction being written to a datastore of NSO and propagated to the network. In some examples, when the transaction is propagated to the network, the NSO is configured to check if the device is in sync with the NSO's datastore by checking that the read and write operations included by the transactional object are similar, nearly the same or the same on the device. If the device is in sync, the changes are persisted on the device. If the device is not in-sync, the NSO is configured to collect one or more or all of the OOB changes as an MCCD and processes the MCCD in accordance with a framework.

In a second case, for example, an on-change subscription process such as a YANG-Push or other device event may cause a configuration change delivery to be distributed to one or more network devices and recognized by the network services orchestrator.

In a third case, upon copying over the partial or complete running configuration of the device to the network services orchestrator, the network services orchestrator may be configured to calculate a minimal configuration change difference (referred to as “MCCD”) as an update towards an associated datastore to ensure that the associated datastore is in configured to be sync with the one or more network devices. In some examples, the NSO copies over the full or partial running configuration of the device. The NSO calculates MCCD to determine how to configure an NSO's datastore to be in-sync with a network device.

In some examples, a Minimal Configuration Change Diff (MCCD) arrives at the network services orchestrator. In this instance, the MCCD is traversed. For each configuration node, using service meta-data, the network services orchestrator is configured to find the closest service instance(s) to run OOB policies 255 defined by the identified service instances. The OOB policies 255 of each service are evaluated in the order that the evaluation terminates (e.g., stops) when a first match of a service instance is discovered. Upon the match of the service instance, various actions may occur by the network services orchestrator 120, including the following: If the OOB configuration changes are accepted, attach the OOB configuration to service instance(s); if the OOB configuration changes are ignored, add the OOB configuration to the network services orchestrator datastore; if OOB configuration changes are rejected, using the datastore of the network services orchestrator, may send or distribute the compensating transaction to one or more devices to restore the configuration subtree rooted at the rejected OOB configuration change; redeploy all affected service instances (service instances that have received OOB configuration attached to them).

In some examples, the network services orchestrator may determine or find the closest service instance(s) rather than an exact or approximate match. Using the network services orchestrator's datastore, the network services orchestrator is configured to find the closest parent node to the configuration node in question that has service meta-data on it; the parent's back pointers define which service instances are associated with the OOB configuration.

In some examples, the network services orchestrator may attach an OOB configuration change to one or more service instance(s). In this instance, the network services orchestrator may be configured to record and store operations required or needed to create the OOB configuration on the device under the data or private data of the service instance. Also, in some examples, the operations may be recorded and stored below the private data of the service instance.

In some examples, the network services orchestrator is configured to redeploy some or all affected service instances. For example, one or more service instances that have received OOB configuration are attached or associated with the particular service instance. This, in turn, may ensure that the device configuration mapping is deployed according to the current intent. In some examples, the network services orchestrator is configured to read and execute the configuration change (e.g., OOB configuration change or configuration change from a transactional object) and create operations stored under the private data of the service instance. In some examples, several, nearly all, or all configuration nodes created during the attachment of the service instance or deployment of the device configuration mapping are tagged with service meta-data for identification. Also, reference counters and back pointers point to the service instances with the OOB configuration change. In some examples, the network services orchestrator is configured to attach the OOB configuration change to the affected service instance and then tag the service instance with service meta-data that may enable the OOB configuration change to have a similar lifecycle or existent congruous to a lifecycle or existence of the intent (i.e., an intent centric policy (OOB Policies 255) being enforced).

In some examples, the network services orchestrator is configured to attach the OOB configuration changes to the affected service instances to enable the network services orchestrator to ensure that the OOB configuration changes occur on the device whenever the intent is deployed or when the intent is to be modified.

In some examples, the network services orchestrator is configured to tag the OOB configurations with service meta-data, enabling the network services orchestrator to selectively remove OOB configuration changes from the devices when the intent is removed.

In some examples, the network services orchestrator is configured to enable the configuring of one or more OOB configuration changes that have been approved by intent-centric policies or by user-defined policies and for aligning the OOB configuration changes with a similar or same lifecycle as an intent-based deployment that is being performed. This ensures that consistent policy enforcement is applied and the policy enforcement is optimized for one or more client or network devices in operations (i.e., a streamlined enforcement of OOB configuration changes among devices).

In some alternate examples, various modeling tools may be utilized with the intent of configuration changes described that allow network service and/or application developers to create new models, class diagrams, etc. The developers (e.g., a service intent developer, an application team, or a plugin developer) may create an entity by listing the attributes with appropriate datatypes to represent the domain model. Further, associations may be defined between different entities, such as the network devices 250 within the network. For example, a code generator generates classes, relational mapping files from the entity, and association definitions during the model build process. The classes may then be compiled, and runtime artifacts may be generated. The artifacts may be consumed by applications and/or plugins in the network services orchestrator 120. The relational mapping files in the artifacts may be used by object/relational mapping (ORM) components running in the services.

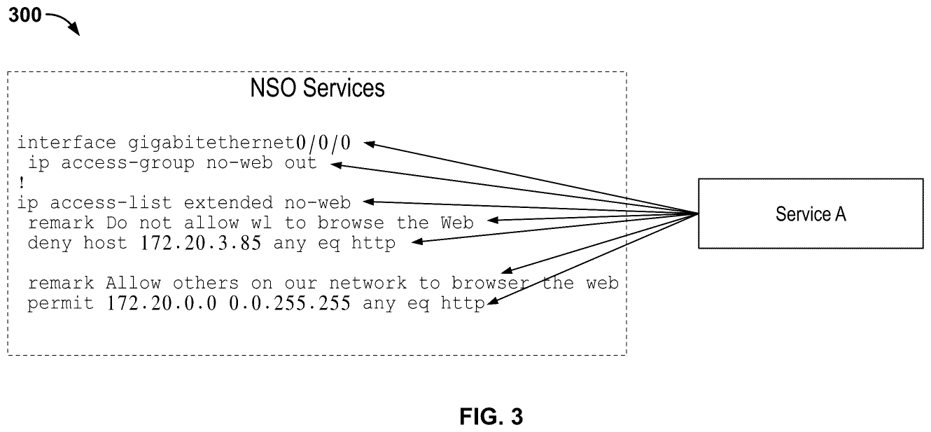

FIG. 3 illustrates a module 300 of code that calls an exemplary service A, which may be deployed for device configuration of a Network Service Orchestrator within the Network Service Orchestrator system of FIG. 1, according to an example of the principles described herein.

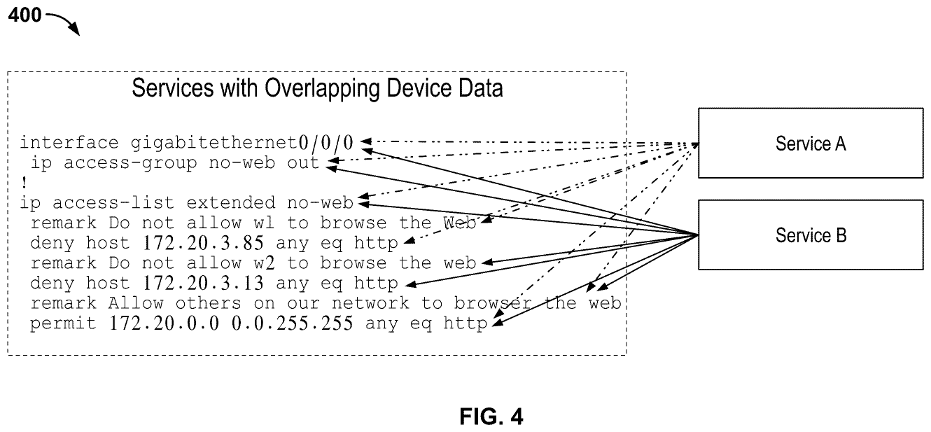

FIG. 4 illustrates a module 400 of code that calls multiple services (e.g., Services A and B) may be deployed for device configuration of a Network Service Orchestrator within the Network Service Orchestrator system of FIG. 1, according to an example of the principles described herein.

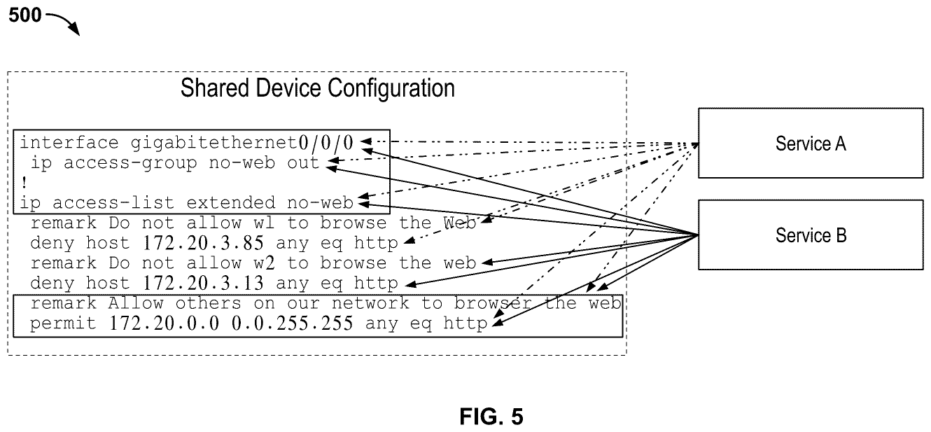

FIG. 5 illustrates a module 500 of code of a shared device configuration of multiple services (e.g., Services A and B) that may be deployed for device configuration of a Network Service Orchestrator within the Network Service Orchestrator system of FIG. 1, according to an example of the principles described herein.

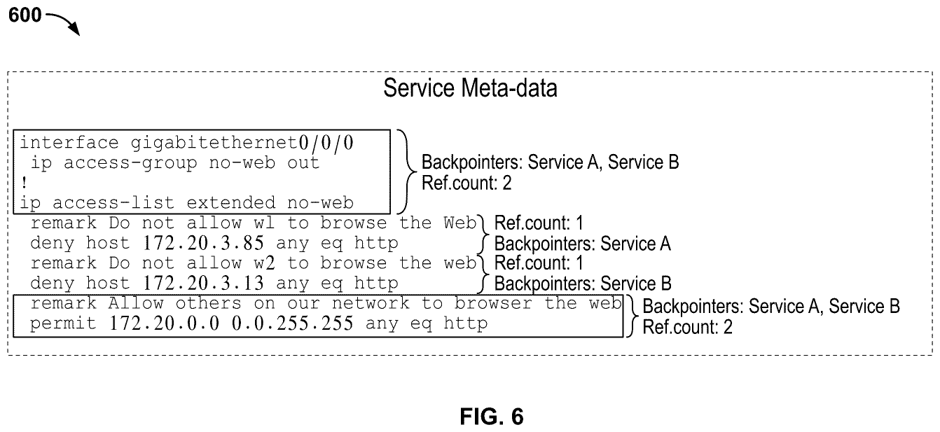

FIG. 6 illustrates a module 600 of code with references to backpointers and counters for a shared device configuration of multiple services (e.g., Services A and B) that may be deployed for device configuration of a Network Service Orchestrator within the Network Service Orchestrator system of FIG. 1, according to an example of the principles described herein.

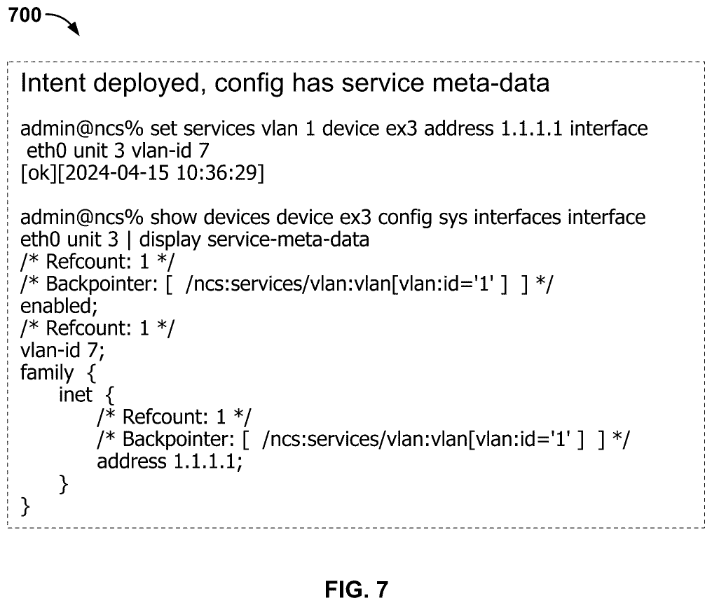

FIG. 7 illustrates a module of code of intent that may be deployed for device configuration with the service meta of a Network Service Orchestrator within the Network Service Orchestrator system of FIG. 1, according to an example of the principles described herein. In FIG. 7, module 700 references the meta-data where an intent (e.g., deploy a VPN service) can be fulfilled by executing the service that describes the intent and maps it to device configurations.

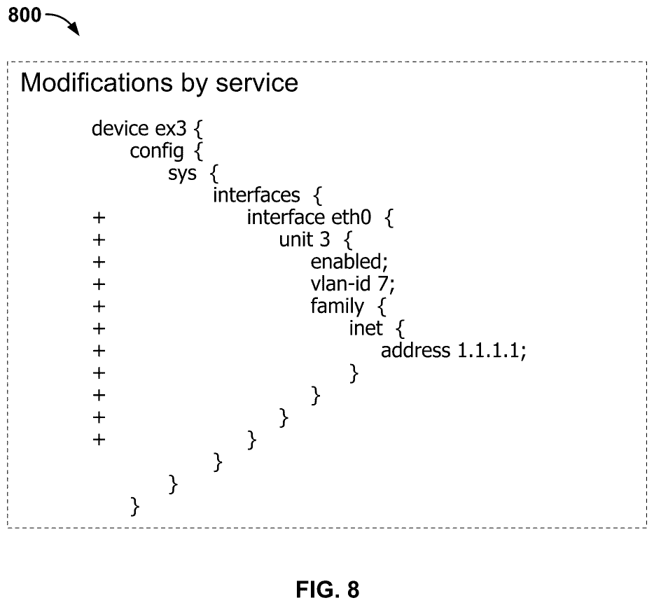

FIG. 8 illustrates a module of code that may be deployed for device configuration in which modifications have been performed by a service instance for use by a Network Service Orchestrator within the Network Service Orchestrator system of FIG. 1, according to an example of the principles described herein. In FIG. 8, module 800 includes modification by a service in the device configuration. In some examples, the code in FIG. 8 illustrates how the service makes and performs changes. The operations for the device mapping of the intent are also described.

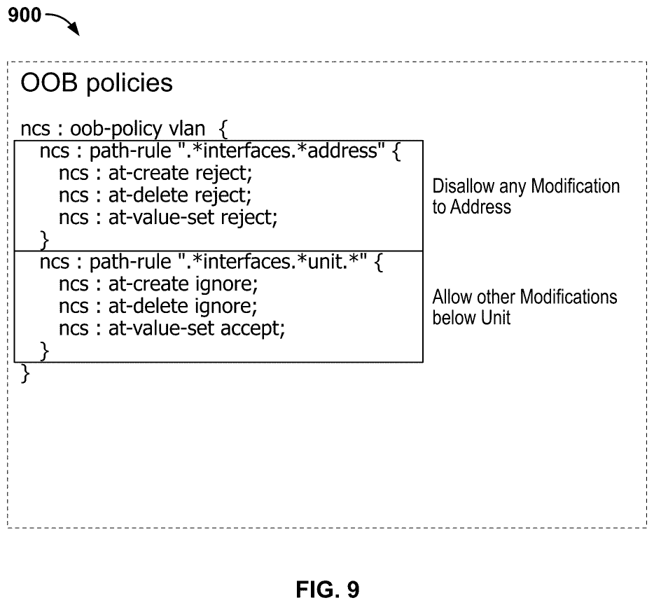

FIG. 9 illustrates a module of code of intent that may be deployed for device configuration with out-of-bound policies used with a Network Service Orchestrator within the Network Service Orchestrator system of FIG. 1, according to an example of the principles described herein. FIG. 9, module 900, illustrates the OOB policies for an exemplary VLAN service. In this instance, there are a set of two exemplary rules. The first rule states that address tampering is restricted to the addresses of an interface owned by a particular service. The first rule prevents unauthorized entities from adding, modifying, or removing addresses. The second rule allows configuration changes below the unit container on any interface owned by the particular service. The second rule enables operators to set extra configuration leaves directly on the network device to fulfill unique customer requests, and these extra configurations may also be attached to the particular service. The creation or deletion of specific dynamic nodes (presence containers, list items) below the unit container is allowed by the operator, but the nodes are prevented from being attached to the particular service; hence, whenever the specific service is redeployed, the OOB configuration changes are not guaranteed to persist.

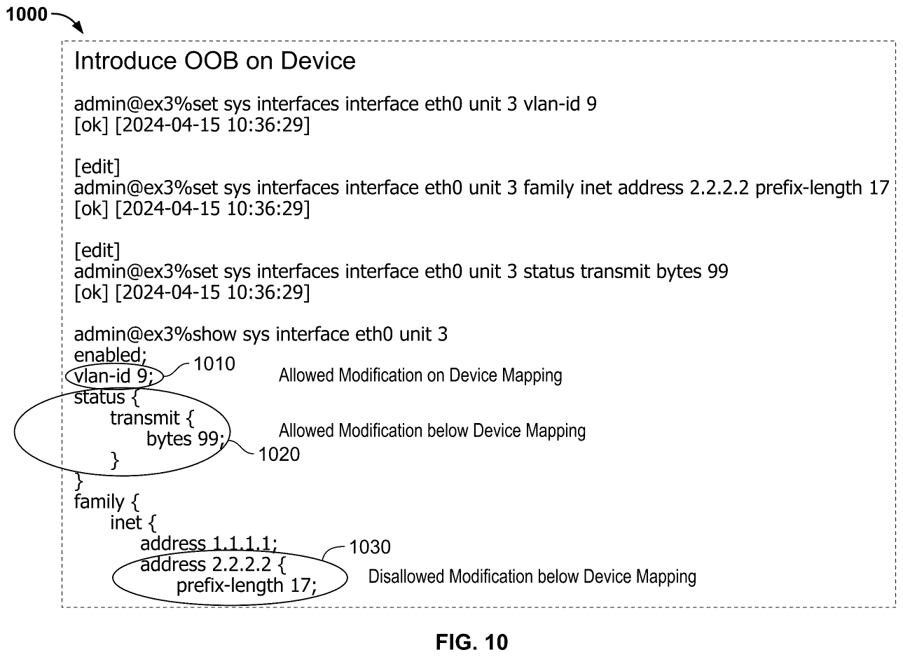

FIG. 10 illustrates a module 1000 of code of intent that may be deployed for device configuration, which allows modification on device mapping, allows modification below a device mapping, and disallows modification below the device mapping for use with a Network Service Orchestrator within the Network Service Orchestrator system of FIG. 1, according to an example of the principles described herein. FIG. 10 shows the OOB configuration changes directly inserted on the example device. FIG. 10 shows an example of device configuration change that may occur for out-of-band mediation from the viewpoint of NSO. The OOB policies of FIG. 9. are shown in FIG. 10 to be matching and the OOB changes that have been configured may be used to define or further explain the policies applied. FIG. 10 also shows the changing of the VLAN-id leaf in the code of module 1000 and setting the bytes leaf, which allows modifications in accordance with the policies and, once made, will be attached to the intent (in accordance with the second rule: “Allow other Modifications below Unit” displayed in FIG. 9) while adding an address ‘2.2.2.2’ to the interface that will be caused to be rejected and removed from the device (in accordance with the first rule “Disallow any Modification to Address” displayed in FIG. 9); thereby changing the VLAN-id leaf 1010, setting the bytes leaf 1020, and disallowing adding an address ‘2.2.2.2’ 1030 to the interface that is owned by the service.

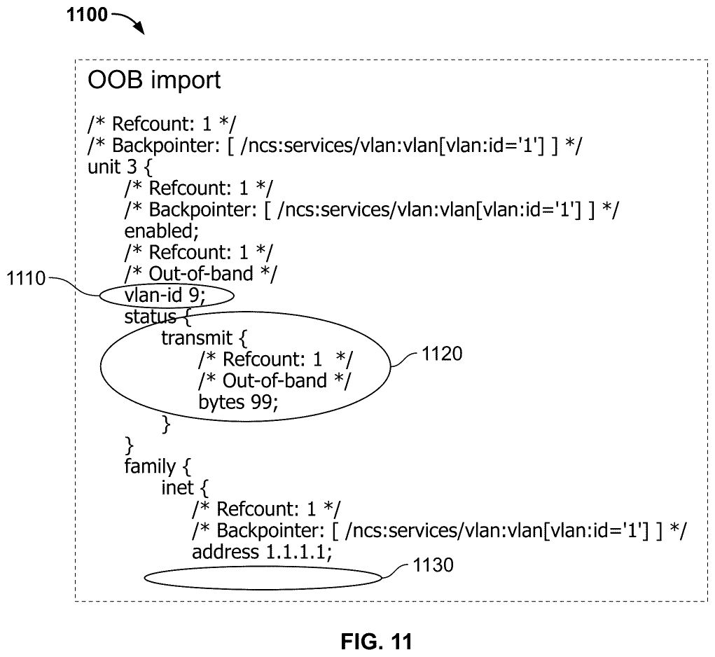

FIG. 11 illustrates a module 1100 of code that triggers a sync operation to the Network Service Orchestrator to recognize OOB configuration changes performed in FIG. 10 within the Network Service Orchestrator system of FIG. 1, according to an example of the principles described herein. In FIG. 11, module 1100, applies to the Network Service Orchestrator where a sync action is triggered to cause the Network Service Orchestrator to be notified or to recognize that the OOB configuration changes 1110, 1120, and 1130 (shown in FIG. 10) have occurred. In this instance, the OOB configuration changes 1110 and 1120 have been accepted by the policies (as shown in the second rule of FIG. 9). With the acceptance of the policies via the second rule that has been configured, the OOB configuration changes have been attached to the service instance. The OOB configuration changes indicated with a newly created address have been removed 1130 (blank circle) in accordance with the first rule (shown in FIG. 9). A compensating transaction was automatically sent to a particular client device to remove the configuration nodes rooted at the address.

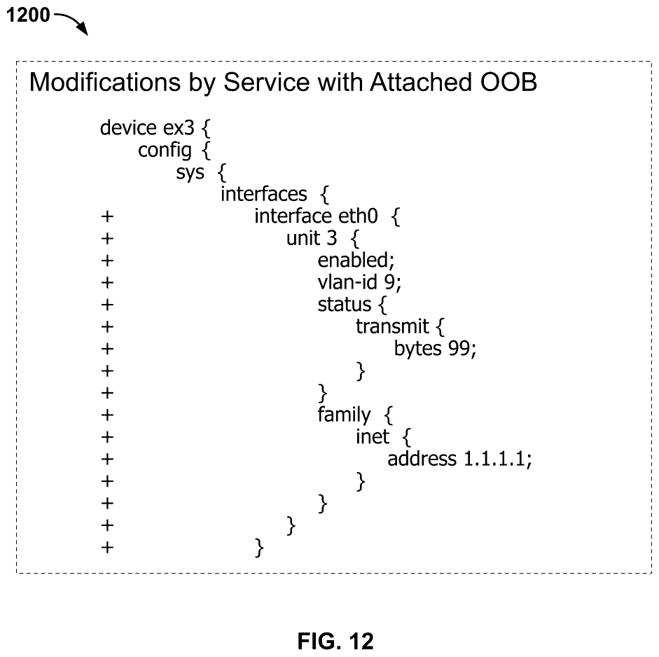

FIG. 12 illustrates a module 1200 of code that may be deployed for device configuration in which modifications have been performed by a service instance with an attached Out-Of-Bound (OOB) configuration change for use by a Network Service Orchestrator within the Network Service Orchestrator system of FIG. 1, according to an example of the principles described herein. In FIG. 12, module 1200 includes modification by a service in the device configuration with the OOB configuration change attached. In some examples, the code in FIG. 12 illustrates how the service makes and performs modifications. Also described are the operations for the device mapping of the intent, with approved OOB configuration changes by the network services orchestrator. As indicated, the process enables a service-centric, policy-enforced view of OOB configuration changes that connect OOB configuration changes with intent. Approved OOB configuration changes will have the same lifecycle as the intent. It also enables fine-grained policy enforcement on OOB configuration changes fully automatedly. In other words, with the framework described, OOB configuration changes approved by user-defined policies will have the same lifecycle as the intent.

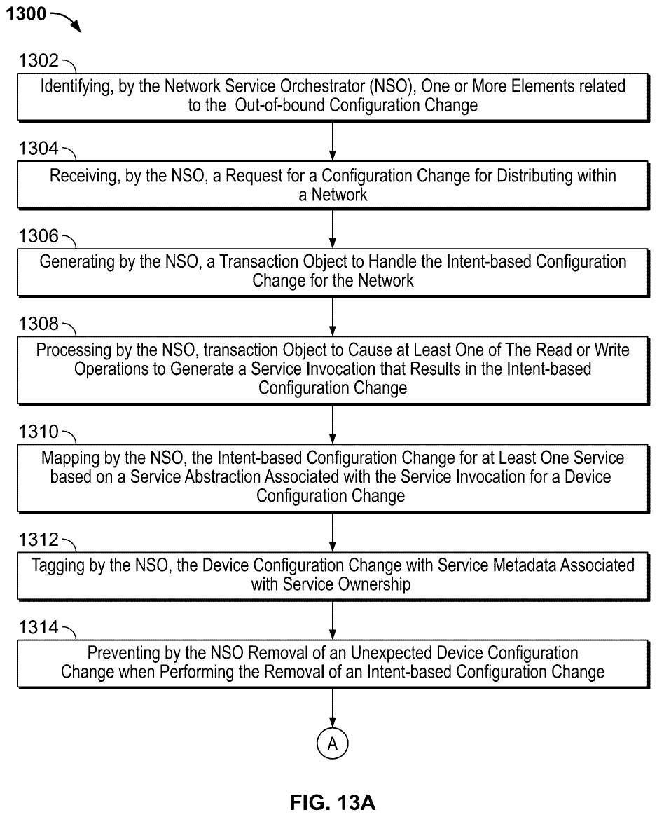

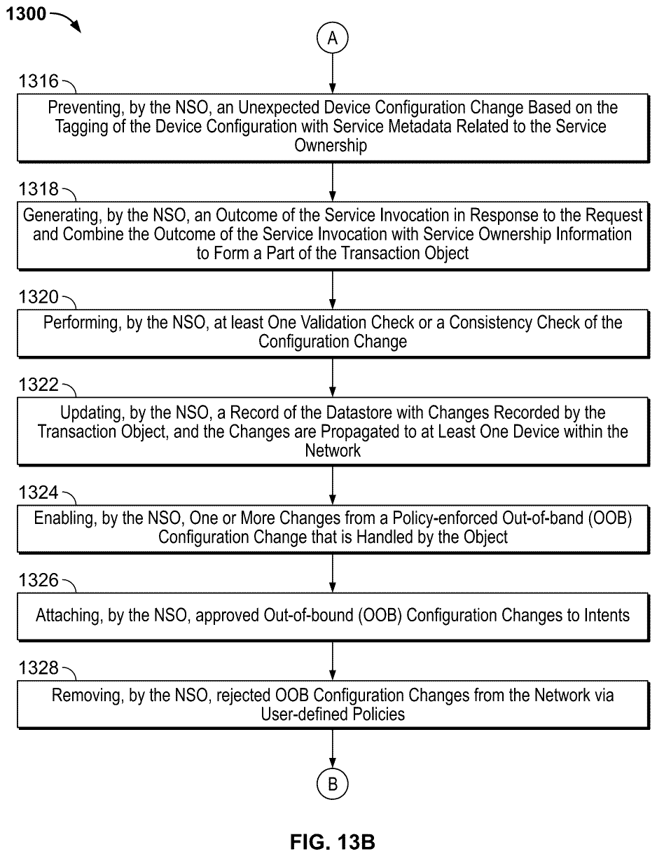

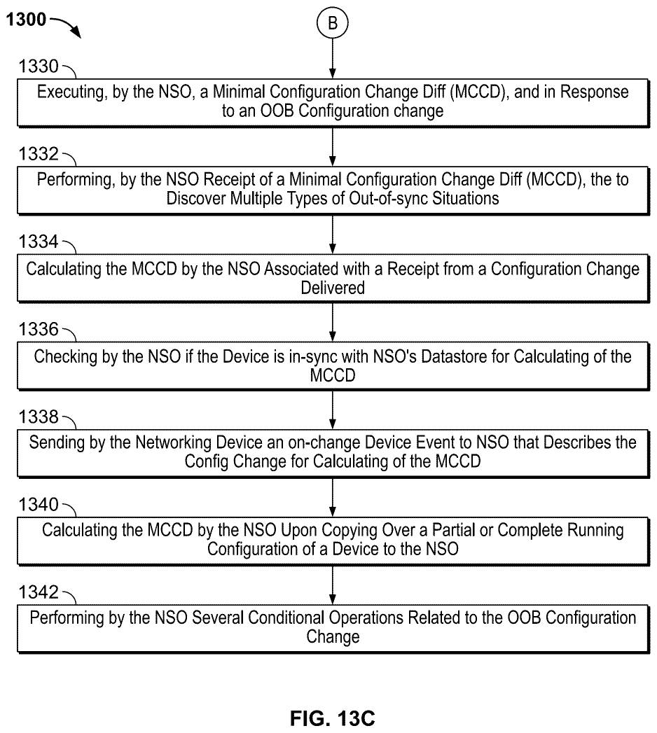

FIGS. 13A, 13B and 13C illustrate flow diagrams of an OOB configuration change method 1300 according to the principles described herein. Method 1300 may include, at 1302, identifying with the network device 250 and/or the network services orchestrator 120, and/or other components of a service manager 210, transactional manager 205, transaction object 215, device abstraction 160, notification API 240, a device configuration 245, out of band (OOB) policies 255, transaction engine 130, device manager 140 and multimodal networks 170.

At 1304, a method is executed for an intent-based change in a network with a controller such as an NSO 120 configured to receive a request for a configuration change for distributing within a network. The configuration change comprises an intent-based configuration change for the network. At 1306, the NSO 120 or other components of the NSO system 100 are configured in whole or in part to assist or solely generate a transaction object to handle the intent-based configuration change for the network. The transaction object is configured to enable at least one read operation or a write operation by a processing element such as the NSO 120. At 1308, the NSO, for example, is configured to execute or process the transaction object to cause at least one read or write operation to generate a service invocation that results in the intent-based configuration change. At 1310, the NSO 120 or other processing element is configured to map the intent-based configuration change for at least one service based on a service abstraction associated with the service invocation that results in a device configuration change. At 1312, the NSO or other processing element is configured to tag the device configuration change with service meta-data associated with service ownership associated with at least one of the device configuration changes or with the intent-based configuration change for the network.

At 1314, the NSO 120 or other processing element is configured to prevent the removal of an unexpected device configuration change when performing the removal of an intent-based configuration change. At 1316, the NSO 120 is configured in order to avoid the removal of an unexpected device configuration change based on the tagging of the device configuration with service meta-data related to the service ownership.

At 1318, the NSO 120 is configured to generate an outcome of the service invocation in response to the request and combine the result of the service invocation with service ownership information to form a part of the transaction object.

At 1320, the NSO 120 is configured to perform at least one validation or consistency check of the configuration change.

At 1322, the NSO 120 is configured to update a record of the datastore with changes recorded by the transaction object, and the changes are propagated to at least one device within the network.

At 1324, the NSO 120 is configured to enable one or more changes from a policy-enforced out-of-band (OOB) configuration change handled by the object.

At 1326, the NSO 120 is configured to attach approved out-of-bound (OOB) configuration changes to intents.

At 1328, the NSO 120 is configured to remove rejected OOB configuration changes from the network via user-defined policies.

At 1330, the NSO 120 is configured to execute initially a minimal Configuration Change Diff (MCCD), and in response to an OOB configuration change, traversing the MCCD and using service meta-data for discovering the closest service instance and for executing at least one OOB policy defined by an identified service instance wherein the OOB policies are evaluated based on a priority of definitions, terminating upon an appropriate match.

At 1332, the NSO is configured to process the receipt of a Minimal Configuration Change Diff (MCCD). The NSO is configured to discover multiple types of out-of-sync situations that result upon a configuration change delivery via incoming device events and when copying over the running configuration of the device to the NSO's datastore.

At 1334 (in the first case), from a receipt from a configuration change delivered, the NSO is configured to process the received configuration change. In some instances, the configured changed being delivered is an intent-based configuration change. The NSO can be configured to process the change as part of a transactional object in which a service invocation is performed. The service invocation process may cause a service output to be tagged with service meta-data that becomes part of the transactional object. Then, the NSO may perform a transaction validity check and, based on confirmation of the validity check, cause the transaction to be written to a datastore communicatively coupled with the NSO and also propagated to the network.

At 1336, upon the transaction being propagated to the network, the NSO is configured to check if the device is in-sync with NSO's datastore. In some instances, the NSO is configured to check that similarities of one or more read-and-write operations that a transactional object has included are the same on the device. If the device is in sync, the changes are persisted on the device. If the device is not in-sync, NSO collects OOB changes as MCCD and further may initiate processing the MCCD in accordance with a certain framework defined. The transaction is written to the datastore of NSO and propagated to the network.

At 1338, (in a second case) of an out-of-sync situation where a configuration change is caused by an on-change subscription process such as a YANG-push or other device event. In this instance, the OOB is handled via a device event. The configuration change happens on a networking device (NSO is not involved). The networking device sends an on-change device event to NSO. The event describes the config change. The NSO is configured to interpret the event and calculate an MCCD using the configuration change described in the event. Processing MCCD starts with the framework.

At 1340 (in a third case), upon copying over a partial or complete running configuration of a device to the NSO. The NSO is configured to copy over the full or partial running configuration of the device.

In some instances, the MCCD is calculated by the NSO in accordance with at least one of the first, second, or third cases for forwarding toward a communicatively connected datastore for enabling the datastore to be synced with one or more configured network devices.

At 1342, the NSO 120 is configured to perform the operations of, if OOB configuration changes are accepted, attaching an OOB configuration to the service instance; if at least one OOB configuration change is ignored, adding at least one OOB configuration to a datastore, and if the OOB configuration changes are rejected, using the datastore for sending a compensating transaction to a device for restoring the configuration subtree rooted at the rejected OOB configuration change.

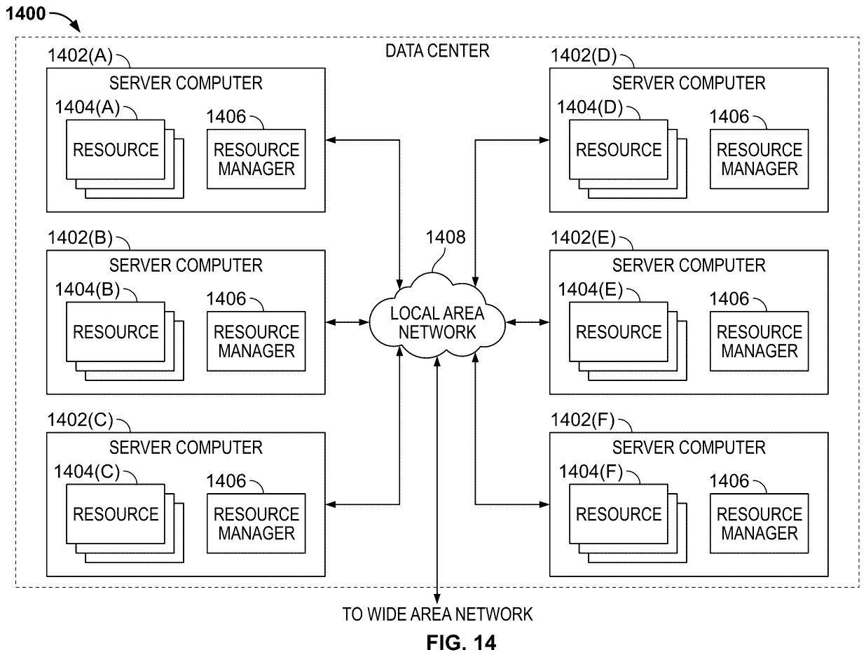

FIG. 14 illustrates a computing system diagram illustrating a configuration for a data center 1400 that may be utilized to implement aspects of the technologies disclosed herein. The example data center 1400 shown in FIG. 14 includes several server computers 1402A-1402F (which might be referred to herein singularly as “a server computer 1402” or in the plural as “the server computers 1402) for providing computing resources. In some examples, the resources and/or server computers 1402 may include or correspond to any networked device described herein. Although described as servers, the server computers 1402 may comprise any type of networked devices, such as servers, switches, routers, hubs, bridges, gateways, modems, repeaters, access points, etc.

The server computers 1402 may be a standard tower, rack-mount, or blade server computers configured appropriately for providing computing resources. In some examples, the server computers 1402 may provide computing resources 1404, including data processing resources such as VM instances or hardware computing systems, database clusters, computing clusters, storage clusters, data storage resources, database resources, networking resources, virtual private networks (VPNs), and others. Some server computers 1402 may also be configured to execute a resource manager 1406 capable of instantiating and/or managing the computing resources. In the case of VM instances, for example, the resource manager 1406 may be a hypervisor or another type of program configured to execute multiple VM instances on a single server computer 1402. Server computers 1402 in the data center 1400 may also be configured to provide network and other services.

In the example, data center 1400 shown in FIG. 14, an appropriate LAN 1408 is also utilized to interconnect the server computers 1402A-1402F. It may be appreciated that the configuration and network topology described herein have been greatly simplified and that many more computing systems, software components, networks, and networking devices may be utilized to interconnect the various computing systems disclosed herein and to provide the functionality described above. Appropriate load balancing devices or other types of network infrastructure components may also be utilized for balancing a load between data centers 1400, between each of the server computers 1402A-1402F in each data center 1400, and, potentially, between computing resources in each of the server computers 1402. It may be appreciated that the configuration of the data center 1400 described with reference to FIG. 14 is merely illustrative and that other implementations may be utilized.

In some examples, the server computers 1402 and or the computing resources 1404 may each execute/host one or more tenant containers and/or virtual machines to perform techniques described herein.

In some instances, the data center 1400 may provide computing resources, like tenant containers, VM instances, VPN instances, and storage, on a permanent or as-needed basis. Among other types of functionality, the computing resources provided by a cloud computing network may be utilized to implement the various services and techniques described herein. The computing resources 1404 provided by the cloud computing network may include various computing resources, such as data processing resources like tenant containers and VM instances, data storage resources, networking resources, data communication resources, network services, VPN instances, and the like.

Each type of computing resource 1404 provided by the cloud computing network may be general-purpose or available in several specific configurations. For example, data processing resources may be available as physical computers or VM instances in a number of different configurations. The VM instances may be configured to execute applications, including web servers, application servers, media servers, database servers, some or all of the network services described above, and/or other programs. Data storage resources may include file storage devices, block storage devices, and the like. The cloud computing network may also be configured to provide other computing resources 1404 not mentioned herein.

The computing resources 1404 provided by a cloud computing network may be enabled in one example by one or more data centers 1400 (which might be referred to herein singularly as “a data center 1400” or in the plural as “the data centers 1400). The data centers 1400 are facilities that house and operate computer systems and associated components. The data centers 1400 typically include redundant and backup power, communications, cooling, and security systems. The data centers 1400 may also be located in geographically disparate locations. One illustrative example of a data center 1400 that may be utilized to implement the technologies disclosed herein is described herein with regard to, for example, FIGS. 1 through 13.

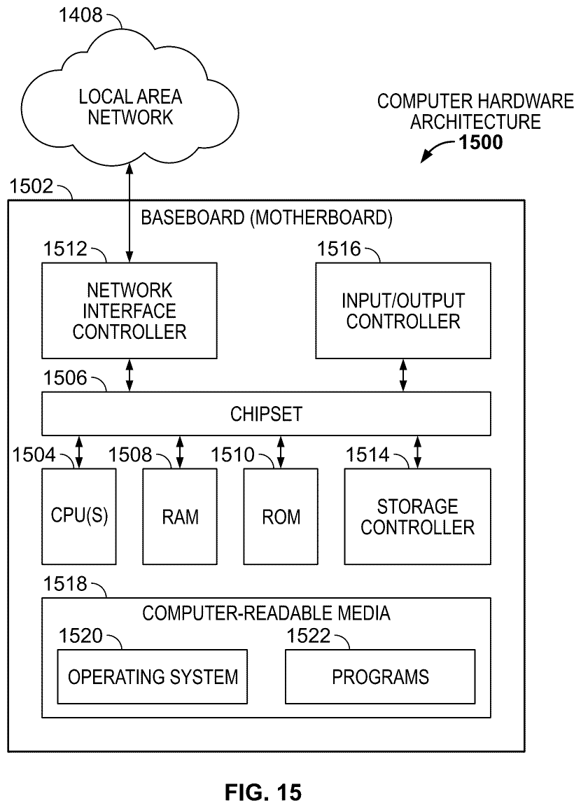

FIG. 15 illustrates a computer architecture diagram showing an example of computer hardware architecture 1500 for implementing a computing device that may be utilized to implement aspects of the various technologies presented herein. The computer hardware architecture (“Computer”) 1500 is shown in FIG. 15 and illustrates the network services orchestrator 120, the local area network (LAN) 1408, and/or other systems or devices associated with the out-of-bound configuration change system (NSO system 100 shown in FIG. 1) and/or other devices remote from the NSO system 100 including a workstation, a desktop computer, a laptop, a tablet, a network appliance, an e-reader, a smartphone, or other computing device, and may be utilized to execute any of the software components described herein. The computer hardware architecture 1500 may, in some examples, correspond to various processing devices (e.g., network services orchestrator 120, network devices 250 (and associated devices) described herein, and may comprise networked devices such as servers, switches, routers, hubs, bridges, gateways, modems, repeaters, access points, etc.

The Computer 1500 may be configured to perform the functionalities of the controller of receiving a Minimal Configuration Change Diff (MCCD) associated with the out-of-sync state occurring in the network; determining by traversing the MCCD and at least one configuration node of the MCCD, a closest service instance associated with service meta-data received by the controller; executing an Out-Of-Bound (OOB) policy associated with a determined closest service instance; and redeploying at least one service instance comprising an OOB configuration change based on an executed OOB policy that is associated with the determined closest service instance.

The Computer 1500 includes a baseboard 1502, or “motherboard,” a printed circuit board to which many components or devices may be connected by way of a system bus or other electrical communication paths. One or more central processing units (CPUs) 1504 operate with a chipset 1506 in one illustrative configuration. The CPUs 1504 may be standard programmable processors that perform arithmetic and logical operations necessary for the operation of the computer 1500.

The CPUs 1504 perform operations by transitioning from one discrete physical state to the next by manipulating switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements may be combined to create more complex logic circuits, including registers, adders-subtractors, arithmetic logic units, floating-point units, and the like.

The chipset 1506 provides an interface between the CPU 1504 and the remainder of the components and devices on the baseboard 1502. The chipset 1506 may provide an interface to a RAM 1508, which is used as the main memory in the computer 1500. The chipset 1506 may further provide an interface to a computer-readable storage medium such as a read-only memory (ROM) 1510 or non-volatile RAM (NVRAM) for storing basic routines that help to startup the computer 1500 and to transfer information between the various components and devices. The ROM 1510 or NVRAM may also store other software components necessary for the operation of the computer 1500 in accordance with the configurations described herein.

The computer 1500 may operate in a networked environment using logical connections to remote computing devices and computer systems through a network, such as the network services orchestrator 120 and network devices 250, among other devices. The chipset 1506 may include functionality for providing network connectivity through a Network Interface Controller (NIC) 1512, such as a gigabit Ethernet adapter. The NIC 1512 is capable of connecting the computer 1500 to other computing devices within the NSO system 100. It may be appreciated that multiple NICs 1512 may be present in the computer 1500, connecting the computer to other types of networks and remote computer systems. In some examples, the NIC 1512 may be configured to perform at least some of the techniques described herein, such as packet redirects and/or other techniques described herein.

The computer 1500 may be connected to a storage device 1518 that provides non-volatile storage for the computer. The storage device 1518 may store an operating system 1520, programs 1522 (e.g., any computer-readable and/or computer-executable code described herein), and data, which have been described in greater detail herein. The storage device 1518 may be connected to the computer 1500 through a storage controller 1514 connected to the chipset 1506. The storage device 1518 may consist of one or more physical storage units. The storage controller 1514 may interface with the physical storage units through a serial attached SCSI (SAS) interface, a serial advanced technology attachment (SATA) interface, a fiber channel (FC) interface, or other type of interface for physically connecting and transferring data between computers and physical storage units.

The computer 1500 may store data on the storage device 1518 by transforming the physical state of the physical storage units to reflect the information being stored. The specific transformation of the physical state may depend on various factors, as shown in different examples of this description. Examples of such factors may include but are not limited to, the technology used to implement the physical storage units, whether the storage device 1518 is characterized as primary or secondary storage, and the like.

For example, the computer 1500 may store information to the storage device 1518 by issuing instructions through the storage controller 1514 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computer 1500 may further read information from the storage device 1518 by detecting the physical states or characteristics of one or more particular locations within the physical storage units.

In addition to the storage device 1518 described above, the computer 1500 may have access to other computer-readable storage media to store and retrieve information, such as program modules, data structures, or other data. It may be appreciated by those skilled in the art that computer-readable storage media is any available media that provides for the non-transitory storage of data and that may be accessed by the computer 1500. In some examples, the operations performed by the network services orchestrator 120 and/or any components included therein may be supported by one or more devices similar to computer 1500. Stated otherwise, some or all of the operations performed by the network services orchestrator 120 and or any components included therein may be performed by one or more computer devices operating in a cloud-based arrangement.

By way of example, and not limitation, computer-readable storage media may include volatile and non-volatile, removable, and non-removable media implemented in any method or technology. Computer-readable storage media includes but is not limited to RAM, ROM, erasable programmable ROM (EPROM), electrically-erasable programmable ROM (EEPROM), flash memory or other solid-state memory technology, compact disc ROM (CD-ROM), digital versatile disk (DVD), high definition DVD (HD-DVD), BLU-RAY, or other optical storage, magnetic cassettes, magnetic tape, magnetic disk storage or other magnetic storage devices, or any other medium that may be used to store the desired information in a non-transitory fashion.

As mentioned briefly above, the storage device 1518 may store an operating system 1520 utilized to control the operation of the computer 1500. According to one example, the operating system 1520 comprises the LINUX operating system. According to another example, the operating system is comprised of the WINDOWS® SERVER operating system from MICROSOFT® Corporation of Redmond, Washington. According to further examples, the operating system may comprise the UNIX operating system or one of its variants. It would be appreciated if other operating systems could also be utilized. The storage device 1518 may store other system or application programs and data used by the computer 1500.

In one example, the storage device 1518 or other computer-readable storage media is encoded with computer-executable instructions which, when loaded into the computer 1500, transform the computer from a general-purpose computing system into a special-purpose computer capable of implementing the examples described herein. These computer-executable instructions transform the computer 1500 by specifying how the CPUs 1504 transition between states, as described above. According to one example, the computer 1500 has access to computer-readable storage media storing computer-executable instructions which, when executed by the computer 1500, perform the various processes described above with regard to FIGS. 1 through 14. The Computer 1500 may also include computer-readable storage media with instructions stored thereupon for performing any of the other computer-implemented operations described herein.

The computer 1500 may also include one or more input/output controllers 1516 for receiving and processing input from a number of input devices, such as a keyboard, a mouse, a touchpad, a touch screen, an electronic stylus, or other type of input device. Similarly, an input/output controller 1516 may provide output to a display, such as a computer monitor, a flat-panel display, a digital projector, a printer, or other type of output device. It will be appreciated that the Computer 1500 might not include all of the components shown in FIG. 15, may include other components that are not explicitly shown in FIG. 15, or might utilize an architecture completely different than that shown in FIG. 15.

As described herein, the computer 1500 may comprise one or more of the network services orchestrator 120 and/or other systems or devices associated with the IBN system 100 and/or remote from the network services orchestrator 120. The Computer 1500 may include one or more hardware processor(s), such as the CPU 1504 configured to execute one or more stored instructions. The CPU 1504 may comprise one or more cores. Further, the Computer 1500 may include one or more network interfaces configured to provide communications between the Computer 1500 and other devices, such as the communications described herein as being performed by the network services orchestrator 120 and other devices described herein. The network interfaces may include devices configured to couple to personal area networks (PANs), wired and wireless local area networks (LANs), wired and wireless wide area networks (WANs), and so forth. For example, the network interfaces may include devices compatible with Ethernet, Wi-Fi™, and so forth.

The programs 1522 may comprise any type of programs or processes to perform the techniques described in this disclosure for the network services orchestrator 120, as described herein. The programs 1522 may enable the devices described herein to perform various operations.

Clause 1. A method for resolving an out-of-sync state occurring in a network, comprising: with a controller: receiving, by the controller, a Minimal Configuration Change Difference (MCCD) associated with the out-of-sync state occurring in the network; determining, by the controller, by traversing the MCCD and at least one configuration node of the MCCD, a closest service instance associated with service meta-data received by the controller; executing, by the controller, an Out-Of-Bound (OOB) policy associated with a determined closest service instance; and redeploying, by the controller, at least one service instance comprising an OOB configuration change based on an executed OOB policy that is associated with the determined closest service instance.

Clause 2. The method of clause 1, further comprising: determining, by the controller, whether to accept the OOB configuration change associated with the executed OOB policy; and in response to a determination of acceptance of the OOB configuration change, attaching, by the controller, the OOB configuration change to the determined closest service instance wherein an accepted OOB configuration change is configured with a similar lifecycle to the at least one service instance.

Clause 3. The method of clause 1, further comprising: determining, by the controller, whether to ignore the OOB configuration change associated with the executed OOB policy; and in response to a determination to ignore the OOB configuration change, adding, by the controller, the OOB configuration change to a datastore wherein the datastore is operatively coupled to the controller.

Clause 4. The method of clause 1, further comprising: determining, by the controller, whether to reject the OOB configuration change associated with the executed OOB policy; and in response to a determination of a rejection of the OOB configuration change, restoring, by the controller, an OOB configuration change associated with a determined closest instance.

Clause 5. The method of clause 4, further comprising: using, by the controller, a datastore operatively coupled to controller, for the determination of the rejection of the OOB configuration associated with the executed OOB policy wherein the OOB policies comprise at least one rule of a plurality of rules wherein the at least one rule comprises a matching expression corresponding to at least one action of a plurality of actions.

Clause 6. The method of clause 1, further comprising: processing, by the controller, the OOB configuration change that is delivered to controller by using a transactional object.

Clause 7. The method of clause 6, further comprising: configuring, by the controller, a service invocation by at least tagging a service output with service meta-data that is attached to the transactional object.

Clause 8. The method of clause 1, further comprising: calculating, by the controller, the MCCD based on a configuration change from an on-device device event sent from a network device to the controller.

Clause 9. The method of clause 1, further comprising: checking, by the controller, if a network device is an in-sync state with controller's datastore based on a similarity of a read operation and a write operation which has been configured by a transactional object wherein if the network device is determined by the controller to be in the in-sync state, a configuration change by the transactional object is persisted on the network device, wherein if the network device is not determined by the controller to be not in the in-sync state, the configuration change by the transactional object is collected for processing the MCCD.

Clause 10. A non-transitory computer-readable medium storing instructions that, when executed, causes a processor to perform operations, comprising: receiving a Minimal Configuration Change Difference (MCCD) associated with an out-of-sync state occurring in a network; determining by traversing the MCCD and at least one configuration node of the MCCD, a closest service instance associated with service meta-data; executing an Out-Of-Bound (OOB) policy associated with a determined closest service instance; and redeploying at least one service instance comprising an OOB configuration change based on an executed OOB policy that is associated with the determined closest service instance.

Clause 11. The non-transitory computer-readable medium of clause 10, when executed, causes a processor to further perform operations, comprising: determining whether to accept the OOB configuration change associated with the executed OOB policy; and in response to a determination of acceptance of the OOB configuration change, attaching the OOB configuration change to the determined closest service instance wherein an accepted OOB configuration change is configured with a similar lifecycle to the at least one service instance.

Clause 12. The non-transitory computer-readable medium of clause 10, when executed, causes a processor to further perform operations, comprising: determining whether to ignore the OOB configuration change associated with the executed OOB policy; and in response to a determination to ignore the OOB configuration change, adding the OOB configuration change to a datastore.

Clause 13. The non-transitory computer-readable medium of clause 10, when executed, causes a processor to further perform operations, comprising: determining whether to reject the OOB configuration change associated with the executed OOB policy; and in response to a determination of a rejection of the OOB configuration change, restoring an OOB configuration change associated with a determined closest instance.

Clause 14. The non-transitory computer-readable medium of clause 13, when executed, causes a processor to further perform operations, comprising: using, a datastore operatively coupled to the processor, for determination of the rejection of the OOB configuration associated with the executed OOB policy.

Clause 15. The non-transitory computer-readable medium of clause 10, when executed, causes a processor to further perform operations, comprising: processing the OOB configuration change that is delivered to controller by using a transactional object; and configuring a service invocation by at least tagging a service output with service meta-data that is attached to the transactional object.

Clause 16. The non-transitory computer-readable medium of clause 10, when executed, causes a processor to further perform operations, comprising: calculating the MCCD based on a configuration change from an on-device device event sent from a network device.

Clause 17. The non-transitory computer-readable medium of clause 10, when executed, causes a processor to further perform operations, comprising: checking if a network device is an in-sync state with controller's datastore based on a similarity of a read operation and a write operation which has been configured by a transactional object wherein if the network device is determined to be in the in-sync state, the configuration change by the transactional object is persisted on the network device, wherein if the network device is not determined to be not in the in-sync state, the configuration change by the transactional object is collected for processing the MCCD.

Clause 18. A network controller comprising: a processor; and a non-transitory computer-readable media storing instructions that, when executed by the processor, causes the processor to perform operations comprising: receiving a Minimal Configuration Change Diff (MCCD) associated with an out-of-sync state occurring in a network; determining by traversing the MCCD and at least one configuration node of the MCCD, a closest service instance associated with service meta-data received; executing an Out-Of-Bound (OOB) policy associated with a determined closest service instance; and redeploying at least one service instance comprising an OOB configuration change based on an executed OOB policy that is associated with the determined closest service instance.

Clause 19. The network controller of clause 18, the operations further comprising: determining whether to accept or to reject the OOB configuration change associated with the executed OOB policy; in response to a determination of acceptance of the OOB configuration change, attaching the OOB configuration change to the determined closest service instance; and in response to a determination to ignore the OOB configuration change, adding the OOB configuration change to a datastore wherein the datastore is operatively coupled to the network controller wherein an accepted OOB configuration change is configured with a similar lifecycle to the at least one service instance.

Clause 20. The network controller of clause 18, the operations further comprising: processing the OOB configuration change that is delivered by using a transactional object; configuring a service invocation by at least tagging a service output with service meta-data that is attached to the transactional object; and calculating the MCCD based on a configuration change from an on-device device event sent from a network device. Although the application describes examples having specific structural features and/or methodological acts, it is to be understood that the claims are not necessarily limited to the specific features or acts described. Rather, the specific features and acts are merely illustrative of some examples that fall within the scope of the claims of the application.

While the present systems and methods are described with respect to the specific examples, it is to be understood that the scope of the present systems and methods are not limited to these specific examples. Since other modifications and changes varied to fit particular operating requirements and environments will be apparent to those skilled in the art, the present systems and methods are not considered limited to the example chosen for purposes of disclosure and cover all changes and modifications that do not constitute departures from the true spirit and scope of the present systems and methods.

Although the application describes examples having specific structural features and/or methodological acts, it is to be understood that the claims are not necessarily limited to the specific features or acts described. Rather, the specific features and acts are merely illustrative of some examples that fall within the scope of the claims of the application.

What is claimed is:

1. A method for resolving an out-of-sync state occurring in a network, comprising: with a controller:
receiving, by the controller, a Minimal Configuration Change Difference (MCCD) associated with the out-of-sync state occurring in the network;
determining, by the controller, by traversing the MCCD and at least one configuration node of the MCCD, a closest service instance associated with service meta-data received by the controller;
executing, by the controller, an Out-Of-Bound (OOB) policy associated with a determined closest service instance; and
redeploying, by the controller, at least one service instance comprising an OOB configuration change based on an executed OOB policy that is associated with the determined closest service instance.

2. The method of claim 1, further comprising:
determining, by the controller, whether to accept the OOB configuration change associated with the executed OOB policy; and
in response to a determination of acceptance of the OOB configuration change, attaching, by the controller, the OOB configuration change to the determined closest service instance wherein an accepted OOB configuration change is configured with a similar lifecycle to the at least one service instance.

3. The method of claim 1, further comprising:
determining, by the controller, whether to ignore the OOB configuration change associated with the executed OOB policy; and
in response to a determination to ignore the OOB configuration change, adding, by the controller, the OOB configuration change to a datastore wherein the datastore is operatively coupled to the controller.

4. The method of claim 1, further comprising:
determining, by the controller, whether to reject the OOB configuration change associated with the executed OOB policy; and
in response to a determination of a rejection of the OOB configuration change, restoring, by the controller, an OOB configuration change associated with a determined closest instance.

5. The method of claim 4, further comprising:
using, by the controller, a datastore operatively coupled to controller, for the determination of the rejection of the OOB configuration associated with the executed OOB policy wherein the OOB policies comprise at least one rule of a plurality of rules wherein the at least one rule comprises a matching expression corresponding to at least one action of a plurality of actions.

6. The method of claim 1, further comprising:
processing, by the controller, the OOB configuration change that is delivered to controller by using a transactional object.

7. The method of claim 6, further comprising:
configuring, by the controller, a service invocation by at least tagging a service output with service meta-data that is attached to the transactional object.

8. The method of claim 1, further comprising:
calculating, by the controller, the MCCD based on a configuration change from an on-device device event sent from a network device to the controller.

9. The method of claim 1, further comprising:
checking, by the controller, if a network device is an in-sync state with controller's datastore based on a similarity of a read operation and a write operation which has been configured by a transactional object wherein if the network device is determined by the controller to be in the in-sync state, a configuration change by the transactional object is persisted on the network device, wherein if the network device is not determined by the controller to be not in the in-sync state, the configuration change by the transactional object is collected for processing the MCCD.

10. A non-transitory computer-readable medium storing instructions that, when executed, causes a processor to perform operations, comprising:
receiving a Minimal Configuration Change Difference (MCCD) associated with an out-of-sync state occurring in a network;
determining by traversing the MCCD and at least one configuration node of the MCCD, a closest service instance associated with service meta-data;
executing an Out-Of-Bound (OOB) policy associated with a determined closest service instance; and
redeploying at least one service instance comprising an OOB configuration change based on an executed OOB policy that is associated with the determined closest service instance.

11. The non-transitory computer-readable medium of claim 10, when executed, causes a processor to further perform operations, comprising:
determining whether to accept the OOB configuration change associated with the executed OOB policy; and
in response to a determination of acceptance of the OOB configuration change, attaching the OOB configuration change to the determined closest service instance wherein an accepted OOB configuration change is configured with a similar lifecycle to the at least one service instance.

12. The non-transitory computer-readable medium of claim 10, when executed, causes a processor to further perform operations, comprising:
determining whether to ignore the OOB configuration change associated with the executed OOB policy; and
in response to a determination to ignore the OOB configuration change, adding the OOB configuration change to a datastore.

13. The non-transitory computer-readable medium of claim 10, when executed, causes a processor to further perform operations, comprising:
determining whether to reject the OOB configuration change associated with the executed OOB policy; and
in response to a determination of a rejection of the OOB configuration change, restoring an OOB configuration change associated with a determined closest instance.

14. The non-transitory computer-readable medium of claim 13, when executed, causes a processor to further perform operations, comprising:
using, a datastore operatively coupled to the processor, for determination of the rejection of the OOB configuration associated with the executed OOB policy.

15. The non-transitory computer-readable medium of claim 10, when executed, causes a processor to further perform operations, comprising:
processing the OOB configuration change that is delivered to controller by using a transactional object; and
configuring a service invocation by at least tagging a service output with service meta-data that is attached to the transactional object.

16. The non-transitory computer-readable medium of claim 10, when executed, causes a processor to further perform operations, comprising:
calculating the MCCD based on a configuration change from an on-device device event sent from a network device.

17. The non-transitory computer-readable medium of claim 10, when executed, causes a processor to further perform operations, comprising:
checking if a network device is an in-sync state with controller's datastore based on a similarity of a read operation and a write operation which has been configured by a transactional object wherein if the network device is determined to be in the in-sync state, the configuration change by the transactional object is persisted on the network device, wherein if the network device is not determined to be not in the in-sync state, the configuration change by the transactional object is collected for processing the MCCD.

18. A network controller comprising:
a processor; and
a non-transitory computer-readable media storing instructions that, when executed by the processor, causes the processor to perform operations comprising:
receiving a Minimal Configuration Change Diff (MCCD) associated with an out-of-sync state occurring in a network;
determining by traversing the MCCD and at least one configuration node of the MCCD, a closest service instance associated with service meta-data received;
executing an Out-Of-Bound (OOB) policy associated with a determined closest service instance; and
redeploying at least one service instance comprising an OOB configuration change based on an executed OOB policy that is associated with the determined closest service instance.

19. The network controller of claim 18, the operations further comprising:
determining whether to accept or to reject the OOB configuration change associated with the executed OOB policy;
in response to a determination of acceptance of the OOB configuration change, attaching the OOB configuration change to the determined closest service instance; and
in response to a determination to ignore the OOB configuration change, adding the OOB configuration change to a datastore wherein the datastore is operatively coupled to the network controller wherein an accepted OOB configuration change is configured with a similar lifecycle to the at least one service instance.

20. The network controller of claim 18, the operations further comprising:
processing the OOB configuration change that is delivered by using a transactional object;
configuring a service invocation by at least tagging a service output with service meta-data that is attached to the transactional object; and
calculating the MCCD based on a configuration change from an on-device device event sent from a network device.
